(19) United States
(12) Patent Application Publication
(10) Pub. No.: US 2018/0210952 A1
(43) Pub. Date: Jul. 26, 2018

(54) MUSIC TRACK SEARCH METHOD, MUSIC TRACK SEARCH DEVICE, AND COMPUTER READABLE RECORDING MEDIUM

(71) Applicant: YAMAHA CORPORATION, Hamamatsu-shi (JP)

(72) Inventor: Hideki TAKANO, Hamamatsu-shi (JP)

(21) Appl. No.: 15/925,088

(22) Filed: Mar. 19, 2018

Related U.S. Application Data
(63) Continuation of application No. PCT/JP2016/077041, filed on Sep. 14, 2016.

(30) Foreign Application Priority Data
Sep. 30, 2015 (JP) 2015-192967

(51) Int. Cl. G06F 17/30

(52) U.S. Cl. CPC G06F 17/30758; G06F 17/30778; G06F 17/30769; G06F 17/30743

(57) ABSTRACT

A music track search method is computer implemented and symbolizes a change in pitch over time in an input voice of a user; and acquires a result of partial sequence matching performed on a plurality of music tracks recorded in a database by using as a query a symbol sequence including the symbolized input voice, with the partial sequence matching being performed based on an edit distance.

### CROSS REFERENCE TO RELATED APPLICATIONS

This application is a Continuation Application of PCT Application No. PCT/JP2016/077041, filed Sep. 14, 2016, and is based on and claims priority from Japanese Patent Application No. 2015-192967, filed Sep. 30, 2015, the entire contents of each of which are incorporated herein by reference.

### BACKGROUND

### Background of the Invention

### Field of the Invention

The present invention relates to a technique of searching for a music track.

### Description of the Related Art

There is known in the art a technique of searching for a music track desired by a user from among a large number of music tracks recorded in a database. For example, Patent Document 1 discloses an incremental music track search device in which a music track that includes a note sequence corresponding to a note sequence designated by a user is searched for in a sequential manner each time a note is designated. Although Patent Document 2 and Non-Patent Document 1 do not relate to a search for a music track, each of these documents do disclose techniques for searching for sequence data, which are in part similar to a search query.

### RELATED ART DOCUMENT

### Patent Documents

Patent document 1: Japanese Patent Application Laid-Open Publication No. 2012-48619

Patent document 2: Japanese Patent Application Laid-Open Publication No. 2008-134706

### Non-Patent Document

Non-Patent Document 1: SAKURAI Yasushi et al. “Stream Processing under the Dynamic Time Warping Distance”, The IEICE transactions on information and systems (Japanese edition), The Institute of Electronics, Information and Communication Engineers, 92(3), 338-350, Mar. 1, 2009

In the technology described in Patent Document 1, a music track that includes a note sequence that matches an input note sequence is obtained as a search result. A drawback of this technique is that an appropriate search result cannot be obtained in a case that an input is a singing voice, since the voice may not be an accurate representation of a desired music track. Neither Patent Document 2 nor Non-Patent Document 1 is directed to a music track search.

### SUMMARY OF THE INVENTION

In view of the above, it is an object of the present invention to provide a technology for rapid searching of a desired music track based on input of a voice.

In one aspect, the present invention provides a computer-implemented music track search method including: symbolizing a change in pitch over time in a user's input voice; and acquiring results of partial sequence matching performed on a plurality of music tracks recorded in a database by using as a query a symbol sequence including the symbolized input voice, the partial sequence matching being based on an edit distance.

In another aspect, the present invention provides a music track search device including: a symbolizer configured to symbolize a change in pitch over time in a user's input voice; and an acquirer configured to acquire results of partial sequence matching performed on a plurality of music tracks recorded in a database by using as a query a symbol sequence including the symbolized input voice, the partial sequence matching being based on an edit distance.

In still another aspect, the present invention can also be understood as a program executable by a computer to execute the above music track search method, as well as a computer-readable recording medium storing such a program.

### BRIEF DESCRIPTION OF THE DRAWINGS

FIG. 1 is a block diagram showing an overview of a music track search system 1 according to an embodiment.

FIG. 2 is a block diagram showing a functional configuration of the music track search system 1.

FIG. 3 is a block diagram showing a hardware configuration of a terminal device 10.

FIG. 4 is a block diagram showing a hardware configuration of a server device 20.

FIG. 5 is a sequence chart showing an outline of an operation of the music track search system 1.

FIG. 6 is a flowchart showing details of a process at step S1.

FIG. 7 is a graph showing pitch differences in an input voice.

FIG. 8 is a diagram showing a matrix for calculating the Levenshtein distance.

FIG. 9 is a diagram showing a matching matrix according to the present embodiment.

FIG. 10 is a flowchart showing details of a process at step S3.

FIG. 11 is a diagram showing a search result displayed at step S5.

FIG. 12 is a flowchart showing details of a process at step S7.

FIG. 13 is a diagram showing an example process for calculating a degree of similarity.

FIG. 14 is a block diagram showing a configuration of a karaoke system 5 according to an embodiment.

FIG. 15 is a sequence chart showing an outline of an operation of the karaoke system 5.

### DESCRIPTION OF THE EMBODIMENTS

### 1. CONFIGURATION

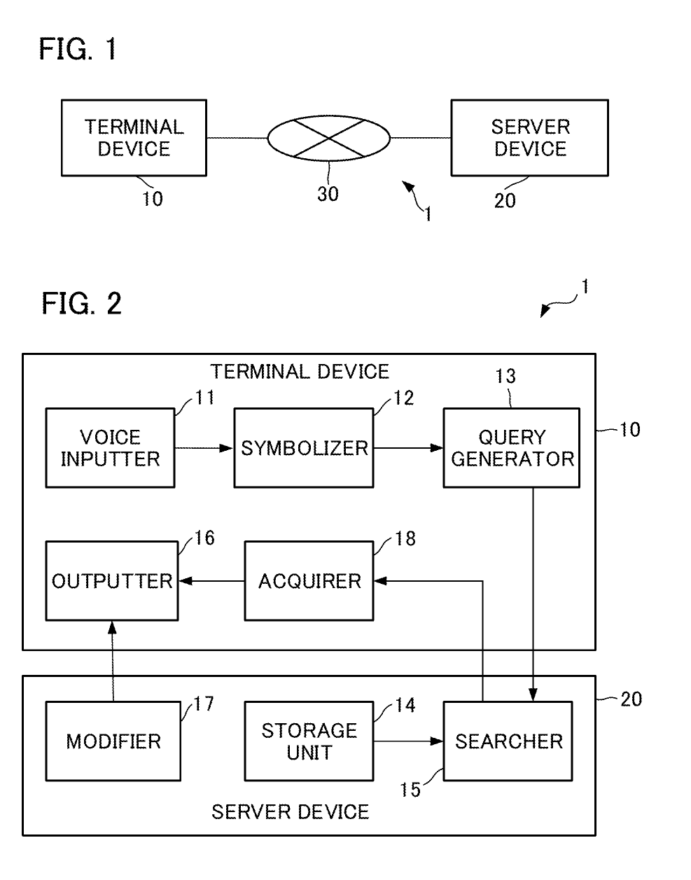

FIG. 1 is a diagram showing an overview of a music track search system 1 according to an embodiment. The music track search system 1 is a system for providing a service (hereafter, “music track search service”) that accepts a user's singing voice as input for a search performed for a music track that includes a part similar to the user's singing voice input, from among a plurality of music tracks recorded in a database. The music track search system 1 includes a terminal device 10 and a server device 20. The terminal device 10 functions as a client in the music track search service, and is an example of a music track search device. The server device 20 functions as a server in the music track search service. The terminal device 10 and the server device 20 are connected to each other via a network 30, and the network 30 may include, for example, at least one of the Internet, a LAN (Local Area Network), and a mobile communications network.

FIG. 2 is a block diagram showing a functional configuration of the music track search system 1. The music track search system 1 includes a voice inputter 11, a symbolizer 12, a query generator 13, a storage unit 14, a searcher 15, an outputter 16, a modifier 17, and an acquirer 18. In the present example, the terminal device 10 implements the functions of the voice inputter 11, the symbolizer 12, the query generator 13, the outputter 16, and the acquirer 18. The server device 20 implements the functions of the searcher 15 and the modifier 17.

The voice inputter 11 accepts input of a user's voice. The symbolizer 12 symbolizes a change in pitch over time in the voice accepted by the voice inputter 11. The query generator 13 generates a search query that includes the input voice symbolized by the symbolizer 12.

The storage unit 14 stores a database in which information on a plurality of music tracks is recorded. The searcher 15 searches the database stored in the storage unit 14 for a music track that includes a part similar to the search query generated by the query generator 13. The searcher 15 employs a search algorithm that uses partial sequence matching based on an edit distance. The partial sequence matching involves identifying a part similar to the search query within an object with which the search query is to be matched (hereafter, “matching object”), which in this example is a music track. The part similar to the search query is referred to as a “similar section”. The modifier 17 modifies a search result obtained by the searcher 15 by use of a method that is different from the partial sequence matching based on the edit distance. This modification is performed for music tracks of a prescribed number, and the prescribed number of music tracks are ranked in order starting from that having a highest degree of similarity among the search result provided by the searcher 15. The modifier 17 modifies the search result based on onset time differences.

The outputter 16 outputs the search results of the searcher 15, and the modified search results of the modifier 17.

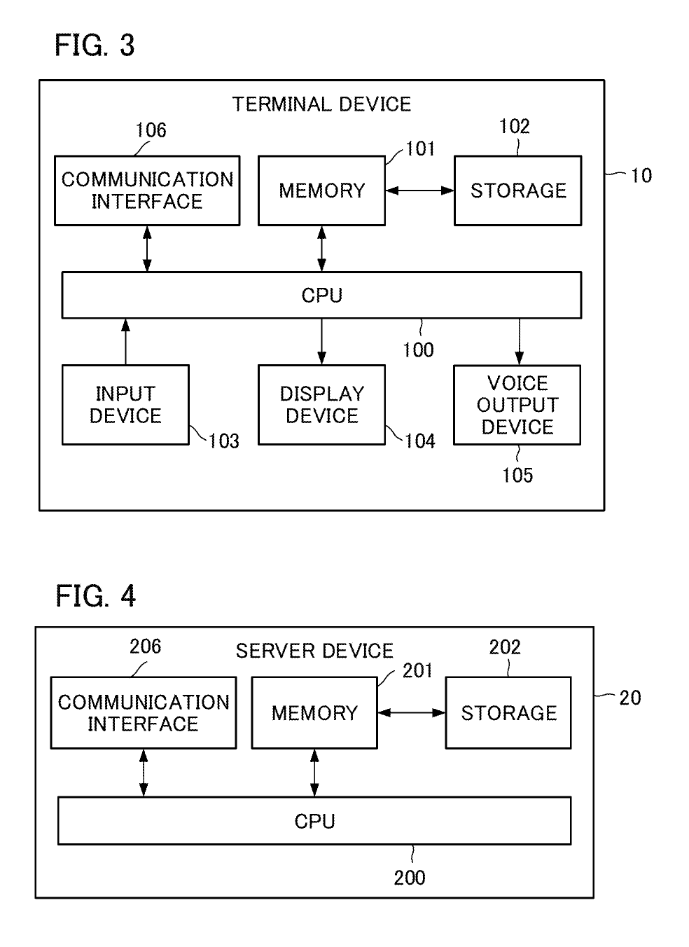

FIG. 3 is a block diagram showing a hardware configuration of the terminal device 10. The terminal device 10 may be, for example, a tablet terminal, a smartphone, a mobile phone, or a personal computer. The terminal device 10 is a computer device that includes a central processing unit (CPU) 100, a memory 101, a storage 102, an input device 103, a display device 104, a voice output device 105, and a communication interface 106. The CPU 100 is a device that carries out a variety of calculations, and also controls other hardware elements. The memory 101 is a storage device that stores codes and data used by the CPU 100 in executing processes, and includes, for example, a read only memory (ROM) and a random access memory (RAM). The storage 102 is a non-volatile storage device that stores a variety of data and programs, and, for example, includes a hard disk drive (HDD) or a flash memory. The input device 103 is a device for inputting information to the CPU 100, and in the present example, includes at least a microphone. The input device 103 may further include, for example, at least one of a keyboard, a touchscreen, and a remote controller. The display device 104 is a device that outputs a moving image, and includes, for example, a liquid-crystal display or an organic EL display. The voice output device 105 is a device that outputs audio, and includes, for example, a DA converter, an amplifier, and a speaker. The communication interface 106 is an interface by which communication is performed with other devices via the network 30.

The memory 101 and the storage 102 are examples of non-transitory storage media. In the present description, the term “non-transitory” storage medium includes all types of computer-readable storage media, including volatile storage media, with the only exception being that of transitory, propagating signals.

The storage 102 stores an application program (hereafter, “client program”) that causes a computer device to function as a client device in the music track search service. The functions shown in FIG. 2 are implemented by the CPU 100 when executing the client program. The input device 103 (in particular, the microphone) is an example of the voice inputter 11. The CPU 100 that executes the client program is an example of the symbolizer 12, the query generator 13, and the acquirer 18. The display device 104 is an example of the outputter 16.

FIG. 4 is a block diagram showing a hardware configuration of the server device 20. The server device 20 is a computer device that includes a CPU 200, a memory 201, a storage 202, and a communication interface 206. The CPU 200 is a device that carries out a variety of calculations, and also controls other hardware elements. The memory 201 is a storage device that stores codes and data used by the CPU 200 in executing a process, and includes, for example, a ROM and a RAM. The storage 202 is a non-volatile storage device that stores a variety of data and programs, and includes, for example, a hard disk drive (HDD) or a flash memory. The communication interface 206 is an interface by which communication is performed with other devices via the network 30.

The memory 201 and the storage 202 are examples of non-transitory storage media.

The storage 202 stores a program (hereafter, “server program”) that causes a computer device to operate as a server device for the music track search service. The functions shown in FIG. 2 are implemented by the CPU 200 when executing the server program. The storage 202 is an example of the storage unit 14. The CPU 200 that executes the server program is an example of the searcher 15 and also of the modifier 17.

### 2. OPERATION

### 2-1. Outline

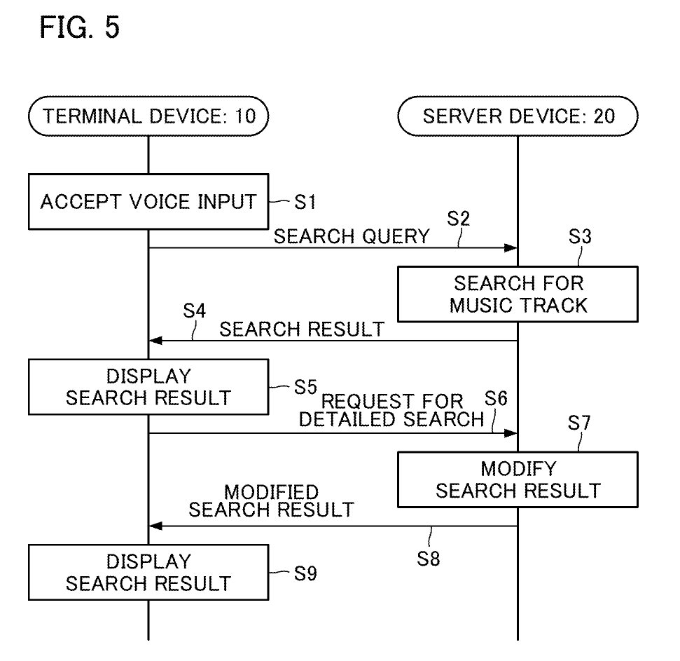

FIG. 5 is a sequence chart showing an outline of an operation of the music track search system 1. At step S1, the terminal device 10 accepts input of the user's voice. At step S2, the terminal device 10 transmits to the server device 20 a search query generated based on an input search instruction. The search query is an information request issued to a search engine, and includes a search key. The search key includes a symbolized input voice. At step S3, the server device 20 searches for a music track in accordance with the received search query. Here, a search is performed using a search algorithm for partial sequence matching based on an edit distance. At step S4, the server device 20 transmits a search result to the terminal device 10. At step S5, the terminal device 10 displays the search result. In the present example, the search is performed in an incremental manner. That is, the process from steps S1 to S5 is triggered by a prescribed event and performed repeatedly. In other words, generation of a search query, a search for a music track, and output of a result are performed repeatedly in conjunction with input of the voice.

At step S6, the terminal device 10 requests the server device 20 to carry out a more detailed matching search. At step S7, the server device 20 modifies the search result based on onset time differences for music tracks of a prescribed number in order from the one with the highest degree of similarity, with degrees of similarity of the music tracks having been determined by use of partial sequence matching based on an edit distance. At step S8, the server device 20 transmits the modified search result. At step S9, the terminal device 10 displays the search result.

### 2-2. Accepting Voice Input

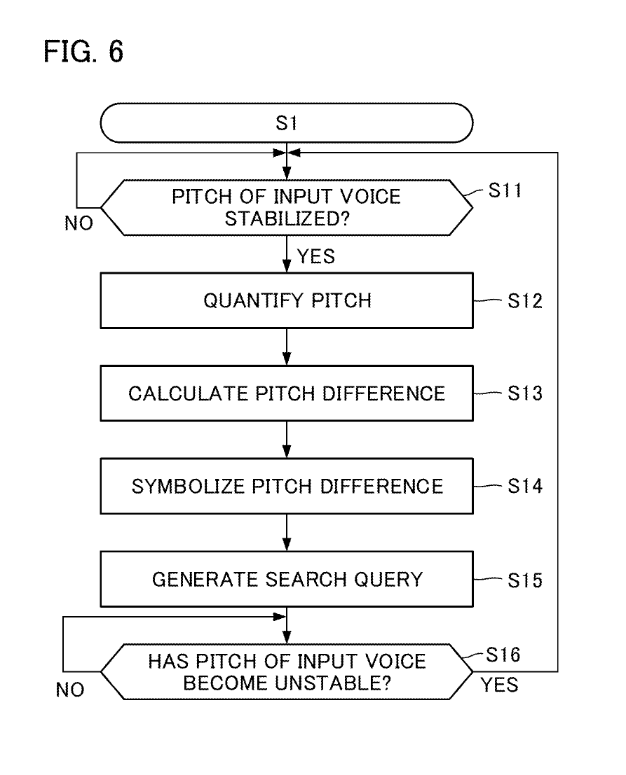

FIG. 6 is a flowchart showing details of the process at step S1. The flow in FIG. 6 is triggered, for example, by an indication made by the user for start of input of the user's voice. The indication by the user for the start of the input of the user's voice is made, for example, via a touch screen, which is the input device 103. In the following description, there may be cases in which software, such as a client program, is described as a subject that executes a process. This means that a processor, such as the CPU 100, upon executing the software executes a process in coordination with other hardware elements.

At step S11, the client program determines whether the pitch of the input voice is stable. The input voice is a singing voice of the user that is input via the microphone, and the microphone is the input device 103. The input singing voice of the user is likely to fluctuate in pitch for a variety of reasons, and thus become unstable. In a case that the pitch of the input voice satisfies a prescribed stability condition, the client program determines that the pitch of the input voice is stable. To establish a prescribed stability condition, there may be employed, for example, a condition where an index of pitch fluctuation falls below a set threshold. As the index of pitch fluctuation, there may be used, for example, dispersion of pitches in an immediately previous prescribed time period, or a difference between a maximum pitch value and a minimum pitch value in an immediately previous prescribed time period. In a case that the pitch of the input voice is determined as being stable (S11: YES), the client program proceeds to step S12. In a case that the pitch of the input voice is determined as not being stable (S11: NO), the client program waits until the pitch becomes stable. The process at step S11 is executed by the voice inputter 11.

At step S12, the client program quantifies the pitch. Specifically, a note that has a pitch range in which the pitch has been determined as being stable at step S11 is quantified at step S12. More specifically, the note is a single note that has a pitch range regarded as a single pitch. The client program stores the quantified pitch in the memory 101.

At step S13, the client program calculates a relative pitch difference between the newly quantified note and the note that was quantified immediately before the new note. The pitch difference ΔP is expressed as

ΔP=P[i]−P[i−1] (1)

where the pitch of the newly quantified note (the i-th note in the input voice) is expressed as P[i].

At step S14, the client program symbolizes the pitch difference AP. The pitch difference is expressed, for example, by appending a symbol (+ or −) representative of a direction of change, to a numerical value based on intervals (relative pitch) in a twelve-tone equal temperament. The symbolized pitch difference ΔP[i] is expressed as S[i]. For example, in a case that P[i] and P[i−1] indicate the same pitch (unison), S[i]=±0. In a case that P[i] is higher than P[i−1] by a minor third, S[i]=+3. In a case that P[i] is lower than P[i−1] by a perfect fifth, S[i]=−7 . The process at steps S12 to S14 is executed by the symbolizer 12.

At step S15, the client program generates a search query. The search query includes, in time sequence, pitch differences that have been detected up to a current time point from a start of voice input. When the i-th note is detected in the input voice, for example, the search query includes symbols indicative of (i−1) pitch differences from S[2] to S[i]. The process at step S15 is executed by the query generator 13.

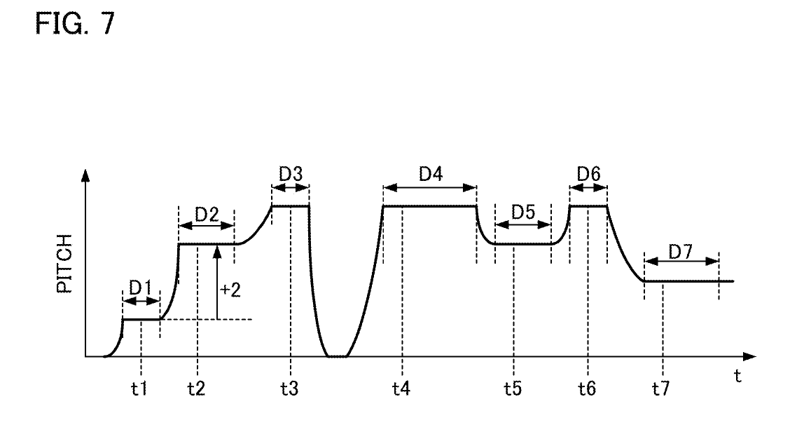

FIG. 7 is a diagram illustrating pitch differences in an input voice. In this figure, the vertical axis represents a pitch and the horizontal axis represents time. Each of periods D1 to D7 indicates a period in which a pitch is determined as being stable. Each of time points t1 to t7 indicates a time point at which a pitch is determined as being stable (i.e., a time point at which a new note is detected) for a corresponding one of periods D1 to D7. Thus, when a new note is detected at time point t2, the symbolized pitch difference of the note between the new note and the immediately preceding note (the note in period D1) is S[t2]=+2.

In the flow in FIG. 6, the client program generates a search query, triggered by detection of a new note. In the present example, the client program generates a search query at each of time points t2 to t7. Each search query generated at each time point includes information on symbolized pitch differences for all notes detected up to a current time point from the start of the voice input (i.e., a sequence of pitch differences); with each one of the symbolized pitch differences corresponding to a difference between each one of a detected note and each one of a note immediately preceding the detected note. For example, the search query Q(t3) generated at time point t3 includes

Q(t3)=(+2, +1) (2)

as a sequence of symbolized pitch differences. The search query Q(t7) generated at time point t7 includes

Q(t7)=(+2, +1, ±0, −1, +1, −2) (3)

as a sequence of symbolized pitch differences.

The sequence of symbolized pitch differences does not include information on note lengths, i.e., a duration of each note; namely, note durations are disregarded. Accordingly, correspondence of length of a newly detected note to a sixteenth note, a half note, and so on, has no influence on the sequence of pitch differences. The only information recorded is that of a pitch difference between one note and an immediately preceding note. Likewise, a rest between notes has no influence on the sequence of pitch differences. Accordingly, whether a note and an immediately following note are contiguous or are separated by a rest, has no influence on symbolized pitch differences.

Reference is again made to FIG. 6. At step S16, the client program determines whether the pitch has become unstable. A criterion of determining whether a pitch is unstable, for example, may be that used at step S11. In a case that a pitch is determined as being stable (S16: NO), the client program waits until the pitch becomes unstable. When the pitch is determined to have become unstable (S16: YES), the client program proceeds to step S11. Thus, a search query is repeatedly and continuously generated for as long as the voice input is maintained. If an instruction for terminating voice input is made by the user, for example, via the touch screen, the client program terminates acceptance of the voice input. Alternatively, the client program may terminate acceptance of the voice input if a period of silence continues up to or beyond a threshold period.

Each time the client program generates a new search query, the client program transmits the newly generated search query to the server device 20 (Step S2). In the example shown in FIG. 7, if a time from generation of a search query to transmission of the search query is not to be taken into consideration, a search query is transmitted at each of time points t1 to t7.

### 2-3. Searching for a Music Track

Before describing operations in detail, the search algorithm will first be described in outline. As stated above, searching involves partial sequence matching based on an edit distance. Before describing the search algorithm of the present embodiment, description of the partial sequence matching based on the edit distance will be given. For an edit distance, a distance defined as the Levenshtein distance is used. The Levenshtein distance is a distance that indicates a degree by which two symbol sequences differ from each other, and is expressed as a least number of edit operations (insertion, deletion, or substitution of a character) required to change one symbol sequence into another symbol sequence. A fuzzy search based on the Levenshtein distance, as compared to other methods, such as a method based on a regular expression or n-gram similarity, is better suited to carrying out a search for a music track based on a voice input, due to the occurrence of fluctuations in accuracy of the input voice.

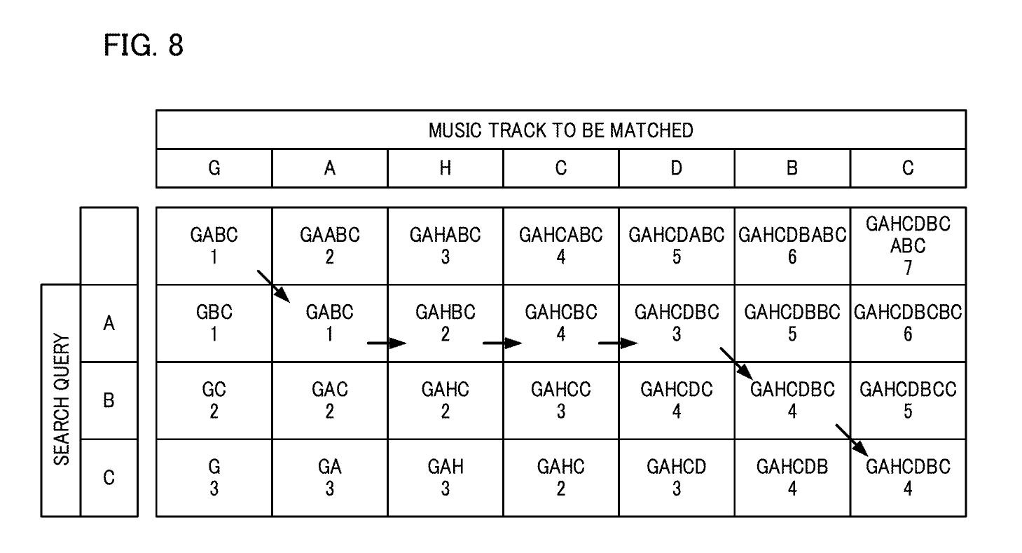

FIG. 8 is a diagram showing a matrix for calculating the Levenshtein distance. Here, an example is used in which the symbol sequence of the matching object (music track) is “GAHCDBC” and the symbol sequence of the search query is “ABC”. In expressions (2) and (3), an example is given in which a symbol consists of a numerical value appended with a positive or negative symbol. For simplification of representation, an example is given below in which a pitch difference is symbolized as a single alphabetic character. In the present example, an edit distance (edit cost) is equivalent for insertion, deletion and substitution, and each edit operation has a cost of “1”.

In the i-th row, j-th column cell (hereinafter, “cell (j, i)”) of this matrix, it is assumed that a symbol sequence consists of a symbol sequence corresponding to the i-th and subsequent symbols of the search query appended to the end of the symbol sequence up to the j-th symbol of the matching object. Hereafter, for each cell such a symbol sequence will be referred to as a “target symbol sequence”. For example, the target symbol sequence in cell (1, 1) is a symbol sequence “GABC” that consists of a symbol sequence “ABC” corresponding to the first and subsequent symbols of the search query appended to the end of a symbol sequence “G” up to the first symbol of the matching object. The target symbol sequence in cell (6, 2) is a symbol sequence “GAHCDBBC” that consists of a symbol sequence “BC” corresponding to the second and subsequent symbols of the search query appended to the end of a symbol sequence “GAHCDB” up to the sixth symbol of the matching object. In FIG. 8, the target symbol sequence is shown in the upper section in each cell.

Next, the Levenshtein distance is calculated for the target symbol sequence in each cell in relation to the search query. For example, in cell (1, 1), since the target symbol sequence is obtained by entering “G” in front of the search query, the edit distance is “1”. In cell (6, 2), the target symbol sequence is obtained by entering “G” in front of the search query and also entering “HCDB” between the first character “A” and the second character “B” of the search query, as a result of which the edit distance is “5”. In FIG. 8, the edit distance thus calculated is shown in the lower portion in each cell.

Generally, in applying the Levenshtein distance, when there is match between symbol sequences, movement occurs in a matrix from a current cell to a lower right cell (downward and to the right); when an addition (insertion) is made in a symbol sequence, movement occurs from the current cell to a right cell (horizontally); and when a deletion is made in a symbol sequence, movement is made to a cell directly below the current cell. Utilization of movement in matrix form in this way, enables an optimal path for editing to be obtained (as indicated by the arrows in FIG. 8). The edit distance shown at the goal of the optimal path (cell (7,4) in the example in FIG. 8) is the Levenshtein distance (“4” in the example in FIG. 8) between the search query symbol sequence and the symbol sequence to be matched. However, this method has two main drawbacks. First, the edit distance increases as the difference in the number of characters between two symbol sequences increases. For example, when there are two music tracks each of which includes a part that perfectly matches the search query, if the lengths of these music tracks are different, the Levenshtein distance will be greater for the longer music track. Second, the method is not suitable for detection of a part similar to the search query (similar section) within the music track to be matched. That is, even when the optimal path (i.e., the shortest path) is followed in the matrix, the path may not necessarily correspond to a path leading to a similar section.

In this regard, a method referred to as SPRING, and which relates to Patent Document 2 and Non-Patent Document 1 is used in the present embodiment. In this method, the Levenshtein distance d is set to zero in the first and last rows of the search query.

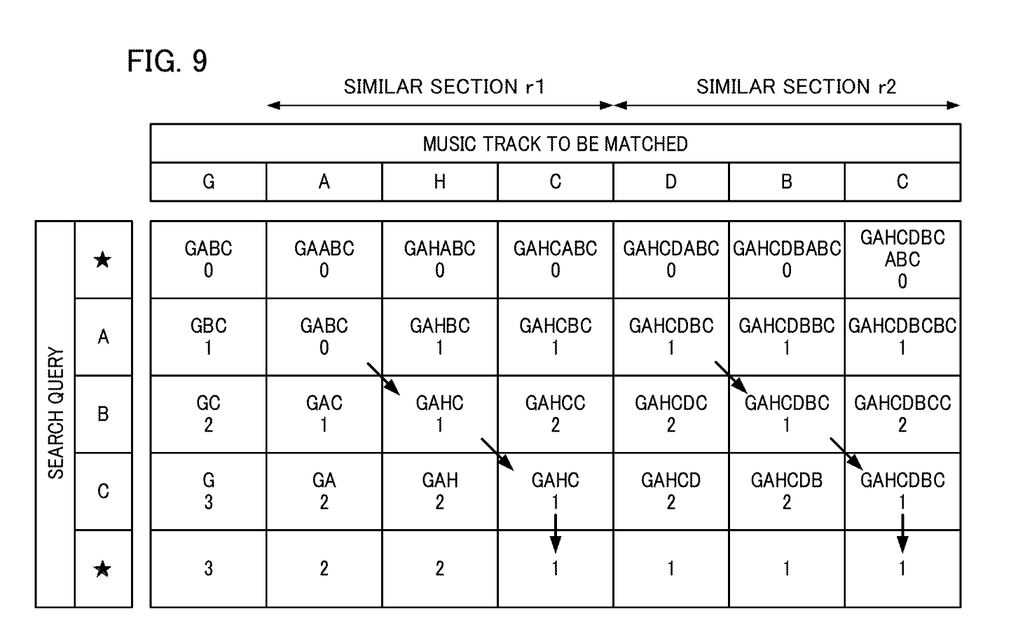

FIG. 9 is a diagram showing a matching matrix according to the present embodiment. The matching matrix corresponds to the matrix shown in FIG. 8 used for calculating an edit distance, and serves to identify a similar section. The concept of the target symbol sequence is substantially the same as that described for FIG. 8. As shown in FIG. 9, the symbol sequence corresponding to the column(s) up to the j-th column of the matching object is appended to the front of the search query (indicated by a star in the search query), and therefore, for all cells in the first row, the search query is equal to the target symbol sequence and the edit distance is zero.

In a cell (j, i) in any of the second and following rows, an edit distance D(j, i) is calculated as follows.

D(j, i)=d(j, i)+min[D(j−1, i−1), D(j−1,i), D(j, i−1)] (4)

Here, d(j, i) stands for the Levenshtein distance between a target symbol sequence in the cell (j, i) and a symbol sequence that consists of a symbol sequence up to the (j−1)th symbol of the matching object appended to the front of a symbol sequence corresponding to the (i−1)th and subsequent symbols of the search query. For example, the target symbol sequence in cell (5, 3) is “GAHCDC”, and a symbol sequence that consists of a symbol sequence “GAHC” up to the fourth symbol of the matching target appended to the front of a symbol sequence “BC” corresponding to the second and subsequent symbols of the search query is “GAHCBC”, and comparison between the two yields d(5, 3)=1. The function “min” represents the least one of arguments. In other words, in the expression above, the right-hand-side second term indicates the least value among the edit distances D among the diagonally upper left, horizontally adjacent left, and horizontally adjacent right cells of the cell in question. For example, there stands:

$$\begin{matrix}D ( 5 , 3 ) = d ( 5 , 3 ) + min [ D ( 4 , 2 ) , D ( 4 , 3 ) , D ( 5 , 2 ) ] \\ = 1 + min [ 1 , 2 , 1 ] \\ = 1 + 1 = 2\end{matrix} . \qquad ( 5 )$$

In the lowest bottom row of the matching matrix (the fifth row in the example in FIG. 9), there are shown least values, each of which is a least value among edit distances among the diagonally upper left, horizontally adjacent left, and horizontally adjacent upper cells of a cell in question. Accordingly, the edit distance recorded in the cell in the lower right corner of the matching matrix indicates the edit distance of a part most similar to the search query within the matching object, i.e., the shortest distance from the search query. In a case that the matching object includes a part that is a perfect match with the search query, the shortest distance to the search query is zero. By use of this method, it is guaranteed that the matching matrix outputs the shortest distance from the search query regardless of a length of a symbol sequence of the matching object. Hereafter, the shortest distance from the search query in a music track will be referred to as a “score”. The score is an index value that shows to what extent a music track is similar to a search query (high or low degree of similarity). In the present example, the score is close to zero, and thus is indicative of the existence of a part that is highly similar to the search query (the degree of similarity is high). If an objective is simply to search for a music track that includes a part similar to a search query, there is no need to store all edit distances of the calculated matching matrix, and storage of a score for each music track may suffice. Moreover, by this method, a single similar section (similar section r2 in the example of FIG. 9) can be identified by way of an optimal path. In this case, an optimal path is one that follows each cell by a shortest possible distance among horizontally adjacent right, diagonally lower right, and horizontally adjacent lower cells. When there are a plurality of cells having the same distances, priority is given to a cell that is “further to the right” and also “further downward”. In FIG. 9, the optimal path corresponds to the path indicated by the arrows. It is of note that in the example described here priority is given to a cell that is “further to the right” and also “further downward” in order to identify an optimal path; however, the plurality of cells having the same distances may be treated as equivalent. In that case, there may be identified a plurality of similar parts that have equal edit distances (similar sections rl and r2 in the example in FIG. 9).

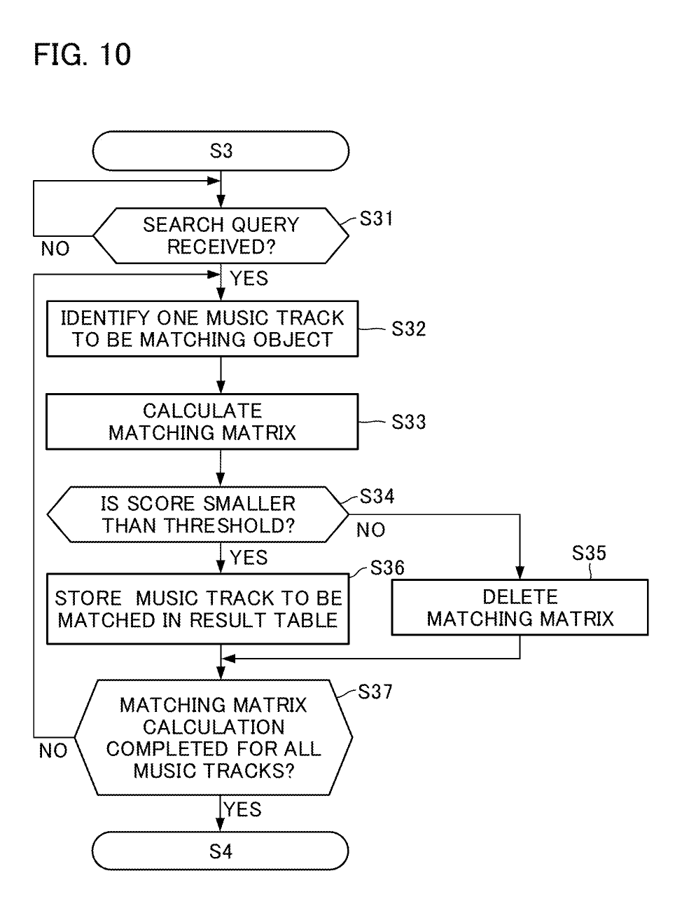

In the flow chart of FIG. 10, details are shown of a process at step S3. The process at step S3 is executed by the searcher 15. At step S31, the server program determines whether it has received a search query from the terminal device 10. When it is determined that a new search query has been received (S31: YES), the server program proceeds to step S32. When it is determined that a new search query has not been received (S31: NO), the server program waits until it receives a search query.

At step S32, the server program identifies, in accordance with a prescribed order, one music track as the matching object from among the music tracks in the database stored in the storage unit 14. The database includes information on each music track, specifically, attribute information, such as an identifier of each music track, and music data for reproducing each music track (e.g., musical instrument digital interface (MIDI) data, uncompressed audio data, such as linear pulse-code modulation (PCM) data, or compressed audio data, such as, for example, data in MP3 format). The database also includes data in which the main melody of each music track is symbolized; for example, the melody of the main vocal section where the music track is a song.

At step S33, the server program calculates a matching matrix for the music track to be matched (specifically, the edit distance in each cell and the least distance (i.e., score) between the search query and the music track). The method of calculating a matching matrix is as described earlier. In calculating a matching matrix, the server program reads the database and uses data of the symbolized melody of the music track to be matched.

At step S34, the server program determines whether the score of the music track to be matched is smaller than a threshold. The threshold may be set in advance, for example. When the score is determined to be equal to or greater than the threshold (S34: NO), the server program deletes the calculated matching matrix from the memory 201 (step S35). When the score is determined to be smaller than the threshold (S34: YES), the server program proceeds to step S36.

At step S36, the server program stores in a result table the identifier and the score of the music track to be matched. The result table is a table that stores information on music tracks having high degrees of similarity (scores smaller than the threshold). The result table also includes information that specifies a similar section in each music track.

At step S37, the sever program determines whether calculation of a matching matrix has been completed for all music tracks recorded in the database. When the server program determines that a music track exists for which a matching matrix has not yet been calculated (S37: NO), the server program proceeds to step S32. At step S32, the next music track becomes a new matching object, and the process from steps S33 to S36 is carried out for the new music track to be matched. When the server determines that calculation of a matching matrix has been completed for all music tracks (S37: YES), the server program proceeds to step S4. At step S4, the server program transmits the result table as a search result to the terminal device 10 having transmitted the search query.

### 2-4. Displaying Search Result

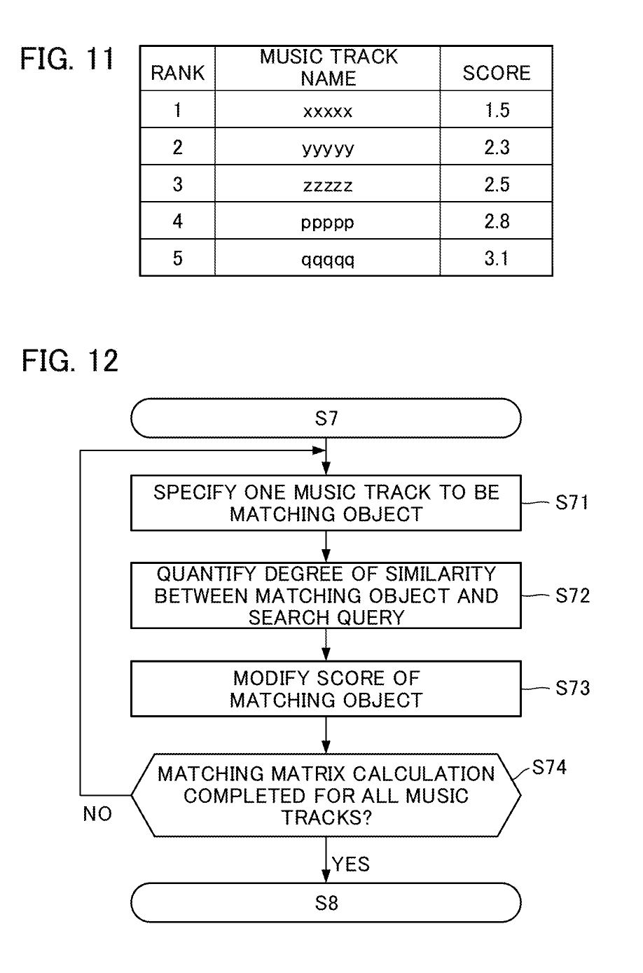

The diagram in FIG. 11 shows an example of a search result displayed at step S5. The client program of the terminal device 10 uses the result table received from the server device 20 to display the search result. The displayed search result includes identifiers (the names of the music tracks in the present example) and scores for a plurality of music tracks. The plurality of music tracks are listed in order from a high degree of similarity to low degree of similarity (i.e., in order from a small score to a great score).

The method of displaying a search result is not limited to the example shown in FIG. 11. For example, in addition to or alternative to identifiers and/or scores of music tracks, there may be displayed information for specifying similar sections (e.g., musical scores or lyrics corresponding to similar sections). Instead of displaying information on multiple music tracks, there may be displayed information on a single music track that has the best score (i.e., the smallest score).

As described in the foregoing, the process from steps S1 to S5 is repeated, and therefore, the search result is updated continuously for as long as input of the voice continues. In an initial period at which input of the voice has just started, it is highly likely that a search result will be influenced by noise due to the shortness of the search query. However, as the search query lengthens with continuing input of the voice, noise will be filtered out enabling searched music tracks to be narrowed down.

### 2-5. Modifying Search Result

When a condition for starting detailed matching is satisfied, the terminal device 10 requests the server device 20 to carry out more detailed matching, i.e., requests that the accuracy of the search result be increased (step S6). The condition for starting detailed matching may be, for example, termination of voice input, or receiving input of an explicit instruction for detailed matching by the user. When the condition is satisfied, the terminal device 10 transmits a request for detailed matching (hereafter, “request for increased accuracy”). The request for increased accuracy includes: information indicating that the request is for detailed matching; a search query; information for specifying target music tracks; and information for specifying a similar section in each music track. The information for specifying the target music tracks includes identifiers of at least some of the music tracks included in the result table obtained at step S4. The phrase, at least some of the music tracks, means, for example, music tracks in the result table ranked from one with a highest degree of similarity to one with a low degree of similarity corresponding to a prescribed rank; for example a first ranked music track to a tenth ranked music track.

The search query included in the request for increased accuracy is information that differs from the search query generated at steps S14 and S15, and includes information on a length of each note. Note length information includes, for example, information indicative of an onset time difference. By onset time difference is meant a time length from a time point at which input of one note starts to a time point at which input of a next note starts. Hereafter, when there is a need to distinguish the search query transmitted at step S6 from the search query generated at steps S14 and S15, the former will be referred to as the “second search query” and the latter will be referred to as the “first search query”. The second search query may be uncompressed audio data or compressed audio data indicative of a waveform of an input voice, or may be data in which an input voice is symbolized together with an onset time difference. The client program stores the input voice in the form of data and uses the stored data to generate the second search query. In the search using the first search query, a time length of a note is disregarded, whereas in the search using the second search query, music tracks are narrowed down by also taking into account a time length of a note.

The flowchart in FIG. 12 shows details of the process at step S7. The process at step S7 is executed by the modifier 17. At step S71, the server program identifies, in accordance with a prescribed order, one music track as the matching object from among the target music tracks included in the request for increased accuracy.

At step S72, the server program compares, within the music track to be matched, the similar section relative to the first search query with the second search query, and quantifies a degree of similarity between the two. In quantifying the degree of similarity, the onset time difference is taken into account. It is of note that instead of an onset time difference, a time length of a section for a voiced sound among an input voice (i.e., time length of a section in which a pitch is detected) may be symbolized in the second search query.

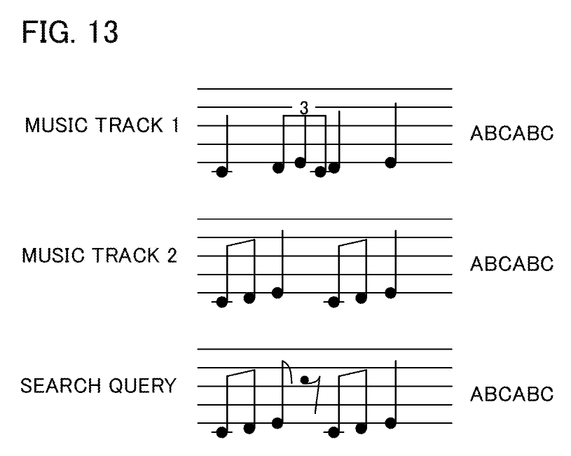

In the diagram in FIG. 13 a process is shown for calculating a degree of similarity. Here, two music tracks (music track 1 and music track 2) are deemed matching objects. In FIG. 13 there is shown only the music scores of similar sections relative to the first search query in the music tracks 1 and 2. As will be understood from the music scores, the two music tracks are different from each other; however, if the information on note lengths is deleted in the process of symbolization at steps S14 and S15, symbols for the two music tracks become identical. Here, symbols “ABCABC” are considered as an example. Since the symbols are identical, the scores of the music tracks 1 and 2 will be identical in the search in the first stage.

FIG. 13 also shows the second search query. The first search query is “ABCABC”. When symbolized together with the onset time differences, the second search query may be expressed as “A(1)B(1)C(1)A(2)B(1)C(1)”, for example. Each of the numbers in the parentheses represents an onset time difference between the note corresponding to the symbol before each number and another note that immediately precedes the note corresponding to the symbol (in the present example, a time length equivalent to an eighth-note is taken as “1”). When the music track 1 is symbolized together with the onset time differences in a similar manner, the music track 1 may be expressed as “A(1)B(2)C(2/3)A(2/3)B(2/3)C(2)”. When the music track 2 is symbolized together with the onset time differences, the music track 2 may be expressed as “A(1)B(1)C(1)A(2)B(1)C(1)”. For the sake of convenience of explanation, the onset time difference of the first note in each of the above symbol sequences is set as “1”.

The server program first calculates an onset time difference between the music track 1 and the search query. Here, a square of an onset time difference is obtained for each note, and the obtained squares for all notes in a similar section are added up. For example, the onset time difference ΔL(1) between the music track 1 and the search query is

$$Δ L ( 1 ) = {( 1 - 1 )}^{2} + {( 2 - 1 )}^{2} + {( \frac{2}{3} - 1 )}^{2} + {( \frac{2}{3} - 2 )}^{2} + {( \frac{2}{3} - 1 )}^{2} + {( 2 - 1 )}^{2} = 4.0 . \qquad ( 6 )$$

Likewise, the onset time difference ΔL(2) between the music track 2 and the search query is

ΔL(2)=0.0 (7)

An onset time difference ΔL indicates that a music track is closely similar to the search query when the value of the onset time difference ΔL is small. In other words, this example shows that the music track 2 is more similar to the search query than the music track 1 (i.e., the degree of similarity to the music track 2 is higher than that to the music track 1). Thus, it can be said that the onset time difference ΔL is a second index value indicative of a degree (high or low) of similarity between a music track to be matched and the second search query. In contrast, it can be said that the score is a first index value indicative of a degree (high or low) of similarity between a music track to be matched and the first search query.

Reference is again made to FIG. 12. At step S73, the server program modifies the score for the music track to be matched, by using the onset time difference calculated at step S72. For example, the server program adds the calculated onset time difference to the score of the music track to be matched, or multiplies the score by the onset time difference.

At step S74, the server program determines whether modification of scores has been completed for all music tracks to be matched that are specified in the request for increased accuracy. When the server program determines that there is a music track for which score modification has not yet been completed (S74: NO), the server program proceeds to step S71. At step S71, the server program specifies a new music track that is to be the matching object, and executes the process at steps S72 and S73 that follow. When the server program determines that score modification has been completed for all music tracks to be matched (S74: YES), the server program transmits a list of the modified scores to the terminal device 10 from which the request for increased accuracy was transmitted (step S8). The terminal device 10 displays the search result (step S9). Display of the result is carried out substantially in the same way as the display of a result at step S5, for example. The result may also be displayed together with information that indicates that the result is final (no more incremental search need be carried out).

### 3. APPLICATION EXAMPLE

Next, an example will be described in which the music track search system 1 is applied to a karaoke device. In the present example, a music track is searched for among karaoke pieces (music tracks) recorded in a database, where input of a singing voice by a user serves as a search query. The music track identified by the search is played so as to follow the singing voice of the user. In other words, in this karaoke device, when the user starts a music track a cappella, a search is made for a music track that accords with the melody of the karaoke piece sung, and karaoke (accompaniment) is played so as to follow the singing of the user.

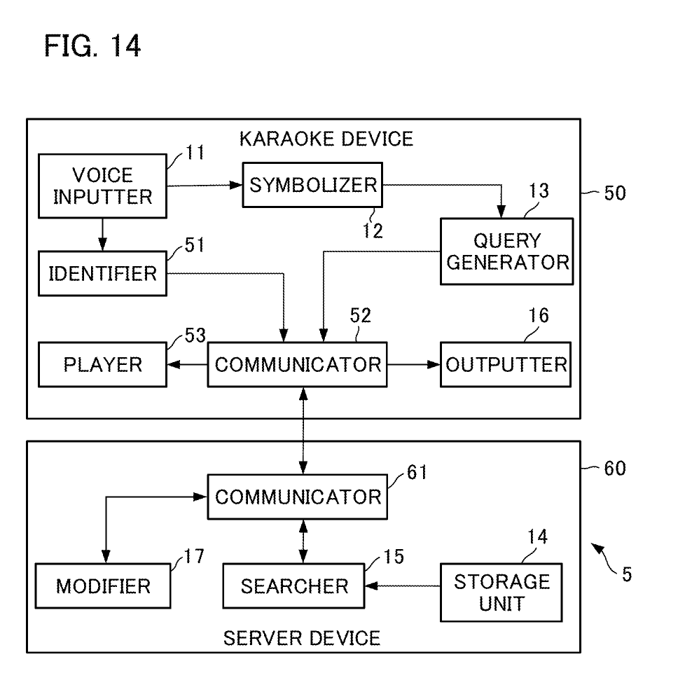

FIG. 14 is a block diagram showing a configuration of a karaoke system 5 according to an embodiment. The karaoke system 5 includes a karaoke device 50 and a server device 60. The karaoke device 50 is a device that performs (plays) a music track selected by the user. The server device 60 stores data of karaoke pieces, and also provides a music track search service. The karaoke device 50 and the server device 60 communicate with each other via the Internet or a dedicated line.

The karaoke device 50 includes a voice inputter 11, a symbolizer 12, a query generator 13, an outputter 16, an identifier 51, a communicator 52, and a player 53. The karaoke device 50 corresponds to the terminal device 10 in the music track search system 1 (i.e., to a music track search device). The voice inputter 11, the symbolizer 12, the query generator 13, and the outputter 16 are as described earlier. From the input singing voice of the user, the identifier 51 acquires a tempo and a key of the singing voice. The communicator 52 communicates with the server device 60. In the present example, the communicator 52 transmits to the server device 60 a search query generated by the query generator 13 and a request for finding one music track, and receives music data from the server device 60. The player 53 plays a music track according to the music data received from the server device 60. The player 53 includes, for example, a speaker and an amplifier.

The server device 60 includes the storage unit 14, the searcher 15, the modifier 17, and a communicator 61. The server device 60 corresponds to the server device 20 in the music track search system 1. The storage unit 14, the searcher 15, and the modifier 17 are as described earlier. The database stored in the storage unit 14 is a database for karaoke pieces. The communicator 61 communicates with the karaoke device 50. The communicator 61 in the present example transmits a search result and music data to the karaoke device 50.

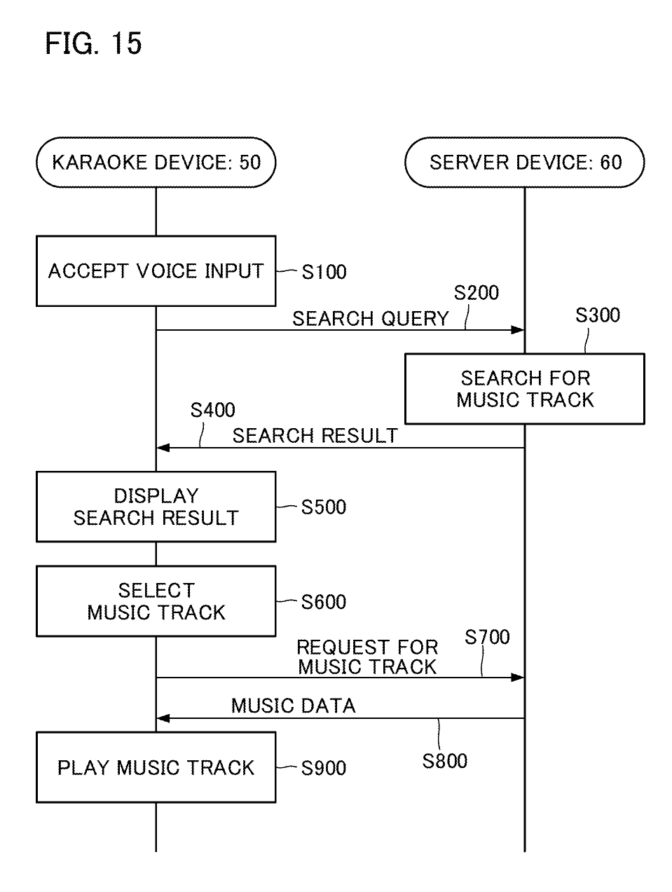

FIG. 15 is a sequence chart showing an outline of an operation of the karaoke system 5. At step S100, the karaoke device 50 accepts voice input. At step S200, the karaoke device 50 transmits the search query to the server device 60. At step S300, the server device 60 searches for music tracks each of which includes a part similar to the search query. At step S500, the karaoke device 50 displays a search result. The process carried out from steps S100 to S500 is substantially the same as that carried out from steps S1 to S9 in the music track search system 1.

At step S600, the karaoke device 50 selects one music track from among the music tracks obtained as the search result. The music track may be selected in accordance with an instruction input by the user, or may be automatically selected by the karaoke device 50 without explicit instruction from the user (e.g., the music track with the highest degree of similarity (lowest score) may be selected by the karaoke device 50 automatically).

At step S700, the karaoke device 50 transmits to the server device 60 a request for the selected music track. The request includes an identifier that specifies the selected music track. The server device 60 transmits to the karaoke device 50 music data of the requested music track. At step S800, the karaoke device 50 receives the music data from the server device 60.

At step S900, the karaoke device 50 plays a karaoke piece in accordance with the received music data. The karaoke device 50 plays the karaoke piece in a tempo and a key extracted from the input voice of the user. The karaoke device 50 extracts from the input singing voice a tempo and key at a freely-selected timing from step S100 to step S800. The karaoke device 50 plays the karaoke piece at the tempo and in the key extracted from the input voice. The karaoke device 50 plays the karaoke piece from a playback point (playback time point) that follows the singing voice of the user. The playback point that follows the singing voice of the user means a playback point that is identified within the selected karaoke piece based on a section similar to the search query. For example, in an ideal system, the karaoke device 50 plays the karaoke piece from a time point at which the similar section ends. In such a system, a time required from which the karaoke device 50 transmits the search query to the server device 60, followed by a request for transmission of the music data to the server device 60, until receipt of music data is complete (i.e., a time difference between the transmission of the search query and the reception of the music data) is almost zero. If the time difference is too large to be ignored, the karaoke device 50 plays the karaoke piece from a time point that is obtained by adding a predicted value of the time difference to the time point at which the similar section ends.

By use of the karaoke system 5, all effort required of a user to search for a desired music track from an enormous list can be eliminated. Moreover, by use of the karaoke system 5, a karaoke piece (accompaniment) is played so as to follow the a cappella singing voice of the user, and thus a new form of entertainment is provided.

It is also possible to terminate a search, for example, at a time point at which the user selects any one of a plurality of music tracks obtained as a search result. For example, the outputter 16 displays a list of a plurality of music tracks found in the search. Specifically, a list is displayed in which names of the plurality of music tracks are listed in ascending order of scores. The manner in which the music tracks are displayed (e.g., by color or size) may differ among the music tracks depending on their scores.

The user can thus select an intended music track from the list. The outputter 16 highlights the music track selected by the user. For example, the music track selected by the user is moved to the top of the list and is displayed in a manner differing from the manner(s) in which the other music tracks are displayed (e.g., in a different color). When a music track is selected in this manner, the search for a music track is terminated, and the search result at this point is deemed the final result. Specifically, generation and transmission of search queries are terminated when the music track is selected by the user, and from this point on, no further search for a music track is performed.

### 4. MODIFICATIONS

The present invention is not limited to the embodiment described above, and a variety of modifications are possible. Some modifications are described below. Two or more of the modifications below may be used in combination.

### 4-1. Modification 1

The method of calculating an edit distance is not limited to the example described in the embodiment. For example, edit costs of insertion, deletion, and substitution may not be equivalent, and may be weighted. Specifically, edit costs of substitution may differ depending on a pitch difference between before and after substitution. For example, an edit cost may be set to decrease as a pitch difference between before and after substitution decreases. When using simple Levenshtein distances, a pitch difference is not taken into consideration, and the edit cost (i.e., the score) remains the same irrespective of whether the difference in pitch from the search query is a semi tone, a fifth, etc. In this example, however, an edit cost decreases in proportion to a decrease in a pitch difference, hence a score value also decreases (a degree of similarity becomes higher) in proportion to a decrease in a pitch difference from the search query. Thus, the degree of similarity can be determined with greater accuracy. Edit costs may be different for different types of edit operations. For example, an edit cost of deletion may be less than that of insertion.

### 4-2. Modification 2

In the mode in which different edit costs are set depending on pitch differences or types of edit operations, edit costs may be determined in accordance with a history of past search queries. For example, with reference to past search queries it may be statistically apparent that a pitch (input) at a specific part of a music track tends to be consistently lower. In a case that a pitch at a specific part of a search query is lower than a pitch in a specific part of the music track, edit costs are set so as to be lower than a case in which the pitch in the specific part in a search query is higher than the pitch in the specific part of the music track. Alternatively, where it is statistically apparent that a specific divergence in pitch tends to occur more readily if a pitch difference in a search query satisfies a specific condition (e.g., when there is an increase in an interval of an octave or more between one note and the next note), edit costs are set in accordance with this tendency.

### 4-3. Other Modifications

An event that triggers generation of a search query is not limited to detection of a new note in the input voice. For example, following passage of a prescribed time period from generation of a most recent search query during input of a voice, a next search query may be generated. Particularly, in an initial voice input period, a search query may be generated when an amount of data of the symbolized input voice exceeds a set threshold. Alternatively, a search query may be generated when a prescribed number of new pitch differences are detected in the input voice. As yet another alternative, a search query may be generated when input of the voice is terminated. In this case, an incremental search is not performed.

A search query for performing partial sequence matching based on an edit distance may include information on an onset time difference. In other words, the symbolizer 12 may symbolize a voice together with information on an onset time difference. The symbolizer 12 may also symbolize an actual pitch instead of a pitch difference. In this case, the searcher 15 converts transition of pitches included in the search query into transition of changes in pitch.

The method of symbolizing pitch differences is not limited to the example described in the embodiment. Symbolization may be carried out based on criteria that are not reliant on intervals in scales in a twelve-tone equal temperament or the like.

The method of increasing accuracy of a search result is not limited to the example described in the embodiment. Any method may be employed so long as the method uses information that is not used in partial sequence matching based on an edit distance.

A part of the functions of the music track search system 1 shown in FIG. 2 may be omitted. For example, the function of the modifier 17, i.e., the function of modifying a search result based on an onset time difference, may be omitted.

The timing at which the modifier 17 modifies a search result is not limited to the example described in the embodiment. For example, in the flowchart shown in FIG. 5, the display of a result at step S5 and the request for a detailed search at step S6 may be omitted. The server device 20 performs the search for a music track (step S3), and then modifies the search result automatically (step S7). In other words, the server device 20 searches for a music track and modifies the search result successively. In this case, the terminal device 10 transmits information on the onset time difference to the server device 20 at step S2. The server device 20 transmits the modified search result to the terminal device 10.

The hardware configuration of the music track search system 1 is not limited to the examples shown in FIGS. 3 and 4. The music track search system 1 may have any hardware configuration so long as the music track search system 1 is capable of realizing the requested functions. Moreover, the correspondence between the functions and the hardware elements is not limited to the example described in the embodiment. For example, the terminal device 10 may have functions that correspond to the searcher 15 and the modifier 17. That is, the search may be performed by the terminal device 10 itself, rather than by the server device 20. In this case, the acquirer 18 acquires results of partial sequence matching that has been performed by the searcher 15 of the terminal device 10 itself. The terminal device 10 may also have a function corresponding to that of the storage unit 14. In other words, the terminal device 10 may store a database. In another example, the symbolizer 12, the query generator 13, and the acquirer 18 may be included in the server device 20, rather than in the terminal device 10. That is, the server device 20 is also an example of the music track search device of the present invention, and the acquirer 18 of the server device 20 acquires a result of partial sequence matching that has been performed by the searcher 15 of the server device 20.

The method of calculating a degree of similarity at step S72 is not limited to the example described in the embodiment. The terminal device 10, when symbolizing an onset time difference within an input voice, may symbolize the input voice after extending the duration of the input voice such that a length thereof becomes equal to a length of a part of the music track to be matched, and corresponding to the input voice (i.e., a length of an input voice may be standardized). In this method, even if there is a difference in tempo between music tracks, a degree of similarity between those music tracks can be determined based on differences in distribution of notes, rests, etc., within a given frame (i.e., a bar). Moreover, the above embodiment employs, as an index of a degree of similarity, a sum of squares of onset time differences between notes in a search query and corresponding notes in a music track to be matched (expression (6)). Alternatively, there may be used a value obtained by averaging absolute values of the onset time differences by the number of notes. By averaging the onset time differences by the number of notes, an onset time difference irrespective of the number of notes can be evaluated. Furthermore, instead of, or in addition to, onset time differences between notes in a search query and corresponding notes in a music track to be matched, there may be used differences in note lengths between a note in the search query and a corresponding note in the music track. If note lengths are to be used, rests also have to be taken into account.

A section within an input voice in which a pitch is not detected may also be reflected in a search query Q. A section in which a pitch is not detected may be a section in which a pitch cannot be detected accurately due to insufficient volume or the like (a silent section), or a section in which a consonant having no harmonic structure is voiced (consonant section).

For example, in a case that a pitch is identical between a section “a” immediately preceding and a section “b” immediately following a silent section or a consonant section, the search query Q is configured to include: a symbol that represents a pitch difference between the section “a” and a section immediately preceding the section “a”; and a symbol that represents a pitch difference (i.e., zero) between the section “b” and the section “a”, for which a pitch is detected immediately before the section “b”. The silent section or the consonant section may be symbolized as a section in which a pitch is absent. Moreover, in the search query contained in the request for increased accuracy, the consonant section may be incorporated into a section immediately following the consonant section, with the immediately following section containing a vowel corresponding to the consonant, so that a time length (onset time difference) of the section may be determined.

The software configuration for providing the music track search service is not limited to the example described in the embodiment. The functions described in the embodiment may be provided not by a single program but by an assembly of a plurality of software components.

The program (e.g., the client program and the server program) for providing the music track search service may be provided by way of a recording medium, such as an optical disc, a magnetic disc, and a semiconductor memory, or may be downloaded via a communication network, such as the Internet.

The application example of the music track search system 1 is not limited to a karaoke system. For example, the music track search system may be applied to a music track search in a music distribution service provided via a network, or to a music track search in a music player.

An invention as set forth in the configurations described below is derived from the above description.

That is, a music track search method according to one aspect of the present invention includes: symbolizing a change in pitch over time in an input voice of a user; and acquiring a result of partial sequence matching performed on a plurality of music tracks recorded in a database by using as a query a symbol sequence including the symbolized input voice, with the partial sequence matching being performed based on an edit distance. In this aspect, a desired music track can be rapidly searched for, based on the input voice.

In a preferred mode, the symbolizing of the change in pitch over time in the input voice may include symbolizing the change as a difference in relative pitch over time. In this mode, the input voice is symbolized as relative pitch differences (e.g., differences in intervals in a twelve-tone equal temperament). Thus, even when pitches of notes in the input voice differ from those in a music track, it is possible to search for a music track that accords with a transition of pitches of notes that are sequential in a melody of the input voice.

Preferably, the symbolizing of the change in pitch over time in the input voice may include symbolizing the time change while disregarding information on time lengths of notes in the input voice. In this mode, it is possible to search for a music track including pitches that match the pitches in the input voice even in a case that durations of notes in the input voice inputted by the user differ from those of corresponding notes in a music track.

In a preferred mode, the music track search method may be configured such that the symbolizing of the change in pitch over time in the input voice is repeated in conjunction with reception of the input voice, and the acquiring of the result of the partial sequence matching is repeated in conjunction with reception of the input voice, and further the method may include outputting the result repeatedly in conjunction with reception of the input voice. In this mode, symbolization of the input voice and acquisition of the result of the partial sequence matching are performed in conjunction with reception of the input voice, and the result also is output in conjunction with reception of the input voice. Thus, the search result can be updated following reception of the input voice, and the user can be informed of a search result by display of a music track that includes matching pitches, while inputting his/her singing voice.

In a preferred mode, in the partial sequence matching, an edit cost used when calculating the edit distance may be weighted depending on a difference between a pitch in the query and a pitch in each music track recorded in the database. In this mode, edit costs decrease in proportion to a decrease in pitch differences. Thus, a music track having smaller pitch differences from the query will have a smaller score value (higher degree of similarity). In this case, a degree of similarity can be determined more accurately.

In a preferred mode, the result of the partial sequence matching may include index values each of which indicates a degree of similarity to the query for a corresponding one of the plurality of music tracks, and the method may further include: modifying the result of the partial sequence matching, for a prescribed number of music tracks with the highest similarity, within the result, in order from a high degree of similarity to a low degree of similarity as indicated by the index values, with the result being modified based on a difference between a time length of a note included in the query and a time length of a note that corresponds to the note in the query in each of the prescribed number of music tracks. In this mode, time lengths of notes are taken into account in addition to changes in pitch over time. Thus, accuracy in a search result can be enhanced.

The present invention can also be understood as a music track search device that executes the music track search method as set forth in the above modes, or as a program that causes a computer to execute the music track search method, or as a computer-readable recording medium that stores the program. Substantially the same effects as those described above are attained by the music track search device, the program, or the recording medium. As described earlier, the music track search device may be realized by the terminal device 10 or the server device 20, or may be realized by these devices working in coordination with each other.

### DESCRIPTION OF REFERENCE SIGNS

1: music track search system
10: terminal device
11: voice inputter
12: symbolizer
13: query generator
14: storage unit
15: searcher
16: outputter
17: modifier
20: server device
30: network
100: CPU
101: memory
102: storage
103: input device
104: display device
105: voice output device
106: communication interface
200: CPU
201: memory
202: storage
206: communication interface

What is claimed is:

1. A computer-implemented music track search method comprising:
symbolizing a change in pitch over time in an input voice of a user; and
acquiring a result of partial sequence matching performed on a plurality of music tracks recorded in a database by using as a query a symbol sequence including the symbolized input voice, with the partial sequence matching being performed based on an edit distance.

2. The music track search method according to claim 1, wherein
the symbolizing of the change in pitch over time in the input voice includes symbolizing the change as a difference in relative pitch over time.

3. The music track search method according to claim 1, wherein
the symbolizing of the change in pitch over time in the input voice includes symbolizing the time change while disregarding information on time lengths of notes in the input voice.

4. The music track search method according to claim 1, wherein
the symbolizing of the change in pitch over time in the input voice is repeated in conjunction with reception of the input voice, and
the acquiring of the result of the partial sequence matching is repeated in conjunction with reception of the input voice,
the method further comprising:
outputting the result repeatedly in conjunction with reception of the input voice.

5. The music track search method according to claim 1, wherein
in the partial sequence matching, an edit cost used when calculating the edit distance is weighted depending on a difference between a pitch in the query and a pitch in each music track recorded in the database.

6. The music track search method according to claim 1, wherein
the result of the partial sequence matching includes index values, each of which indicates a degree of similarity to the query for a corresponding one of the plurality of music tracks,
the method further comprising:
modifying the result of the partial sequence matching, for a prescribed number of music tracks with the highest similarity, within the result, in order from a high degree of similarity to a low degree of similarity as indicated by the index values, wherein the result is modified based on a difference between a time length of a note included in the query and a time length of a note that corresponds to the note in the query in each of the prescribed number of music tracks.

7. A music track search device, comprising:
a symbolizer configured to symbolize a change in pitch over time in an input voice of a user; and
an acquirer configured to acquire a result of partial sequence matching performed on a plurality of music tracks recorded in a database by using as a query a symbol sequence including the symbolized input voice, with the partial sequence matching being performed based on an edit distance.

8. The music track search device according to claim 7, wherein
the symbolizer symbolizes the change in pitch over time in the input voice as a difference in relative pitch over time.

9. The music track search device according to claim 7, wherein
the symbolizer symbolizes the time change while disregarding information on time lengths of notes in the input voice.

10. The music track search device according to claim 7, wherein
the symbolizer symbolizes of the change in pitch over time in the input voice repeatedly in conjunction with reception of the input voice, and
the acquirer acquires the result of the partial sequence matching repeatedly in conjunction with reception of the input voice,
the device further comprising:
an outputter configured to output the result repeatedly in conjunction with reception of the input voice.

11. The music track search device according to claim 7, wherein
in the partial sequence matching, an edit cost used when calculating the edit distance is weighted depending on a difference between a pitch in the query and a pitch in each music track recorded in the database.

12. The music track search device according to claim 7, wherein
the result of the partial sequence matching includes index values, each of which indicates a degree of similarity to the query for a corresponding one of the plurality of music tracks,
the device further comprising:
a modifier configured to modify the result of the partial sequence matching, for a prescribed number of music tracks with the highest similarity, within the result, in order from a high degree of similarity to a low degree of similarity as indicated by the index values, wherein the result is modified based on a difference between a time length of a note included in the query and a time length of a note that corresponds to the note in the query in each of the prescribed number of music tracks.

13. A non-transitory computer-readable recording medium storing a program executable by a computer to execute a music track search method comprising:
symbolizing a change in pitch over time in an input voice of a user; and
acquiring a result of partial sequence matching performed on a plurality of music tracks recorded in a database by using as a query a symbol sequence including the symbolized input voice, with the partial sequence matching being performed based on an edit distance.
